(19) United States
(12) Patent Application Publication
(10) Pub. No.: US 2026/0174002 A1
(43) Pub. Date: Jun. 25, 2026

(54) ROBOTIC MOWER AND A METHOD FOR NAVIGATING THE SAME

(71) Applicant: Greenworks (Jiangsu) Co., Ltd, Changzhou (CN)

(72) Inventor: Andre Lundkvist, Habo (SE)

(21) Appl. No.: 19/540,616

(22) Filed: Feb. 14, 2026

Related U.S. Application Data
(63) Continuation of application No. PCT/CN2023/125321, filed on Oct. 19, 2023.

(51) Int. Cl. A01D 34/00; G05D 1/648; A01D 101/00; G05D 105/15; G05D 107/20

(52) U.S. Cl. CPC A01D 34/008; G05D 1/6484; A01D 2101/00; G05D 2105/15; G05D 2107/23

(57) ABSTRACT

A method for navigating a robotic mower within a work area limited by a boundary and wherein non-cutting zones are definable both inside and outside of the work area is disclosed together with a robotic mower configured to perform the method. The controller of the robotic mower defines parallel lines across the entire work area and the non-cutting zones, processes the parallel lines so that the parallel lines that cross the non-cutting zones, are split into several new lines and that the lines that are inside the non-cutting zones are removed, connects the processed lines to create a complete single coverage path for the robotic mower to follow in order to cut the entire work area excluding the non-cutting zones, and navigates the robotic mower within the work area based on the created single coverage path.

### CROSS REFERENCE TO RELATED APPLICATIONS

The present application is a Continuation Application of PCT Application No. PCT/CN2023/125321 filed on October 19, 2023, the contents of which are incorporated herein by reference in their entirety.

### Technical Field

The present invention relates generally to a robotic mower for performing navigation and a method for navigating the robotic mower. More specifically the present invention relates to path planning for the robotic mower. The present invention also relates to a computer program implementing the method.

### Background Art

Self-propelled robotic mowers have become more and more popular and are now widely used to cut grass within a predetermined work area. The work area is typically limited by boundary wires to ensure that the robotic mower does not move outside the work area and in order to prevent that the robotic mower, objects or living beings get damaged or injured. In newer versions of robotic mowers there are no longer any need for boundary wires. Instead, the robotic mower is provided with a positioning unit used to determine the position of the robotic mower and the robotic mower is allowed to move within a boundary of a predefined work area. The predefined work area may have an irregular shape and also comprise obstacles or non-cutting areas, which the robotic mower should avoid. This makes it difficult to plan an optimal path for the robotic mower. Today the robotic mower is often navigated randomly within the work area. However, for battery powered robotic mowers path planning is important as one wishes to minimize the time it takes to mow the work area. Both to minimize the power consumption and also the time it takes to mow the lawn. The shorter the cutting time the more time the lawn will be accessible for other activities.

Thus, there is a need for a path planning method that takes the above considerations into account.

### Summary of Invention

An object of the present invention is to accomplish navigation of the robotic mower along an optimized planned coverage path.

According to an aspect of the present invention a method for navigating a robotic mower within a work area is disclosed. The work area is limited by a boundary and non-cutting zones are definable both inside and outside of the work area, the method comprising defining parallel lines across the entire work area and the non-cutting zones, processing the parallel lines so that the parallel lines that cross the non-cutting zones, are split into several new lines and that the lines that are inside the non-cutting zones are removed, connecting the processed lines to create a complete single coverage path for the robotic mower to follow in order to cut the entire work area excluding the non-cutting zones, and navigating the robotic mower within the work area based on the created single coverage path.

In one embodiment the connecting of the processed lines into a single coverage path is based on minimizing travelling distance between split co-linear lines.

In another embodiment the split lines are grouped into subsets of lines, which subsets of lines are connected to minimize the total travelling distance between the subsets of lines.

In yet another embodiment the method further comprises combining at least two subsets of lines into composite subsets of lines and connecting the composite subsets of lines with the remaining subsets of lines to minimize the total travelling distance between composite subset of lines and the remaining subsets of lines.

In another embodiment the distance between each parallel line is defined to be equal.

According to another aspect of the present invention a robotic mower for performing navigating within a work area is disclosed. The work area is limited by a boundary and non-cutting zones are definable both inside and outside of the work area. The robotic mower comprises a controller comprising a processor and a memory, wherein the memory comprises instructions which when executed by the processer causes the mower to, define parallel lines across the entire work area and the non-cutting zones, process the parallel lines so that the parallel lines that cross the non-cutting zones, are split into several new lines and that the lines that are inside the non-cutting zones are removed, connect the processed lines to create a complete single coverage path for the robotic mower to follow in order to cut the entire work area excluding the non-cutting zones, and navigate the robotic mower within the work area based on the created single coverage path. Preferably the distance between each parallel line is equal.

In an embodiment the robotic mower is further configured to connect the processed lines into a single coverage path based on minimizing travelling distance between split co-linear lines.

In another embodiment the robotic mower is further configured to group the split lines into subsets of lines, which subsets of lines are connected to minimize the total travelling distance between the subsets of lines.

In yet another embodiment the robotic mower is further configured to combine at least two subsets of lines into composite subsets of lines and connect the composite subsets of lines with the remaining subset of lines to minimize the total travelling distance between composite subsets of lines and the remaining subsets of lines.

According to another aspect of the invention a computer program is disclosed, comprising computer program code, wherein the computer program code is adapted, if executed by the processer of the controller, to implement the methods described above.

Thus, by defining parallel lines across the entire work area and the non-cutting zones and processing the parallel lines so that the parallel lines that cross the non-cutting zones, are split into several new lines and that the lines that are inside the non-cutting zones are removed, it is possible to readily connect these lines to accomplish a single coverage path that increases the efficiency of the robotic mower and reduces the time it takes to cut the entire work area.

### Brief Description of Drawings

The invention is now described, by way of example, with reference to the accompanying drawings, in which:

FIG. 1 is a schematic view of a work area and non-cutting zones in which parallel lines have been defined.

FIG. 2 is a schematic view of a work area and non-cutting zones in which parallel lines have been defined and the wherein split lines are grouped into subsets.

FIG. 3 is a schematic view of the work area, which shows how subsets have been grouped into composite subsets.

FIG. 4 is a flow chart showing the method according to the present invention.

FIG. 5 is schematic view of the robotic mower comprising a controller.

### Description of embodiments

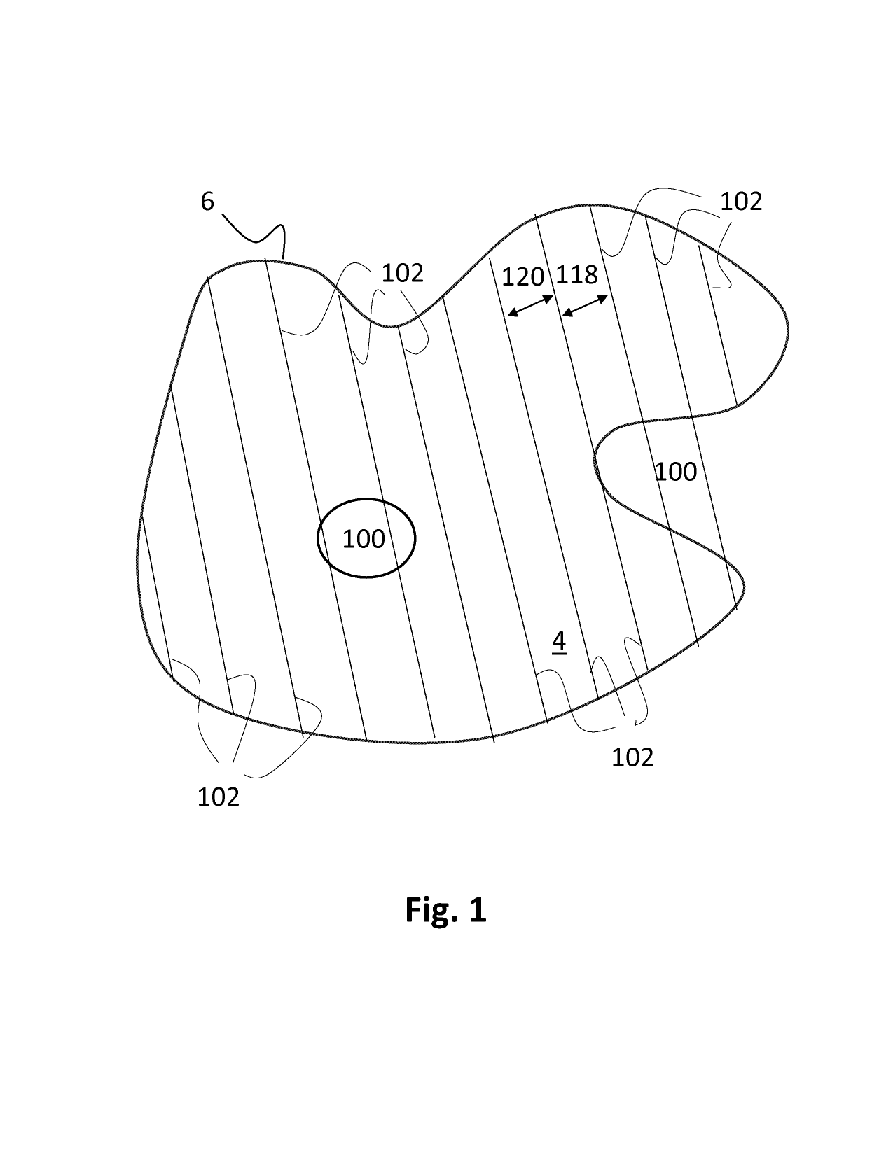

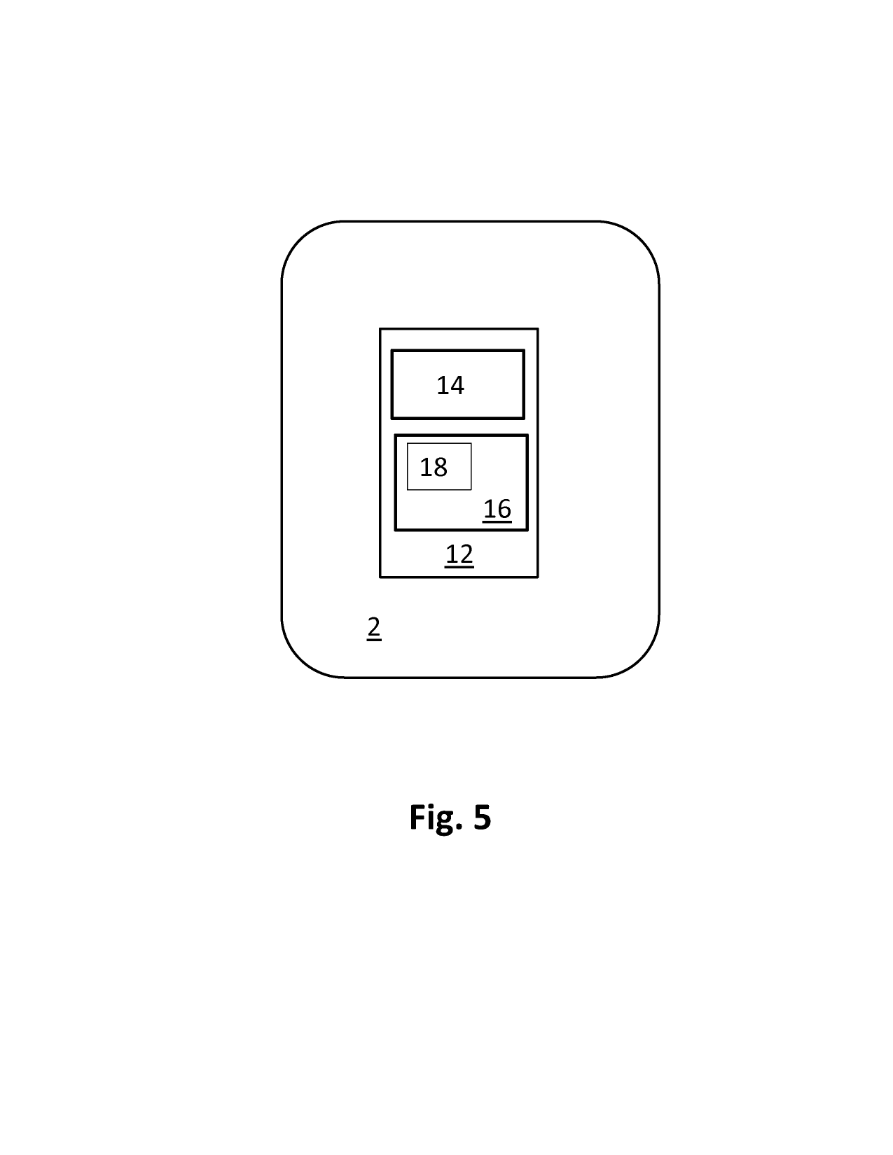

With reference to FIG. 1 the method for navigating a robotic mower 2 (see FIG. 5) will be described. The robotic mower 2 is navigated within a work area 4, which is limited by a boundary 6. FIG. 1 also shows two different non-cutting zones 100. The non-cutting zones 100 can either be definable as being inside or outside the work area 4 or both. Non-cutting zones 100 within the work area 4 are typically obstacles within the work area 4 where the robotic mower cannot cut or is not allowed to cut. Non-cutting zones 100 outside the work area 4 are defined zones through which parallel lines 102 run, when the parallel lines 102 are drawn from one part of the boundary 6 to another part of the boundary 6 due to the irregular shape of the work area 4. Thus, as is evident by looking at FIG. 1, parallel lines 102 have been defined across the entire work 4 are and the non-cutting zones 100. Preferably the distance 118, 120 between each parallel line 102 is equal.

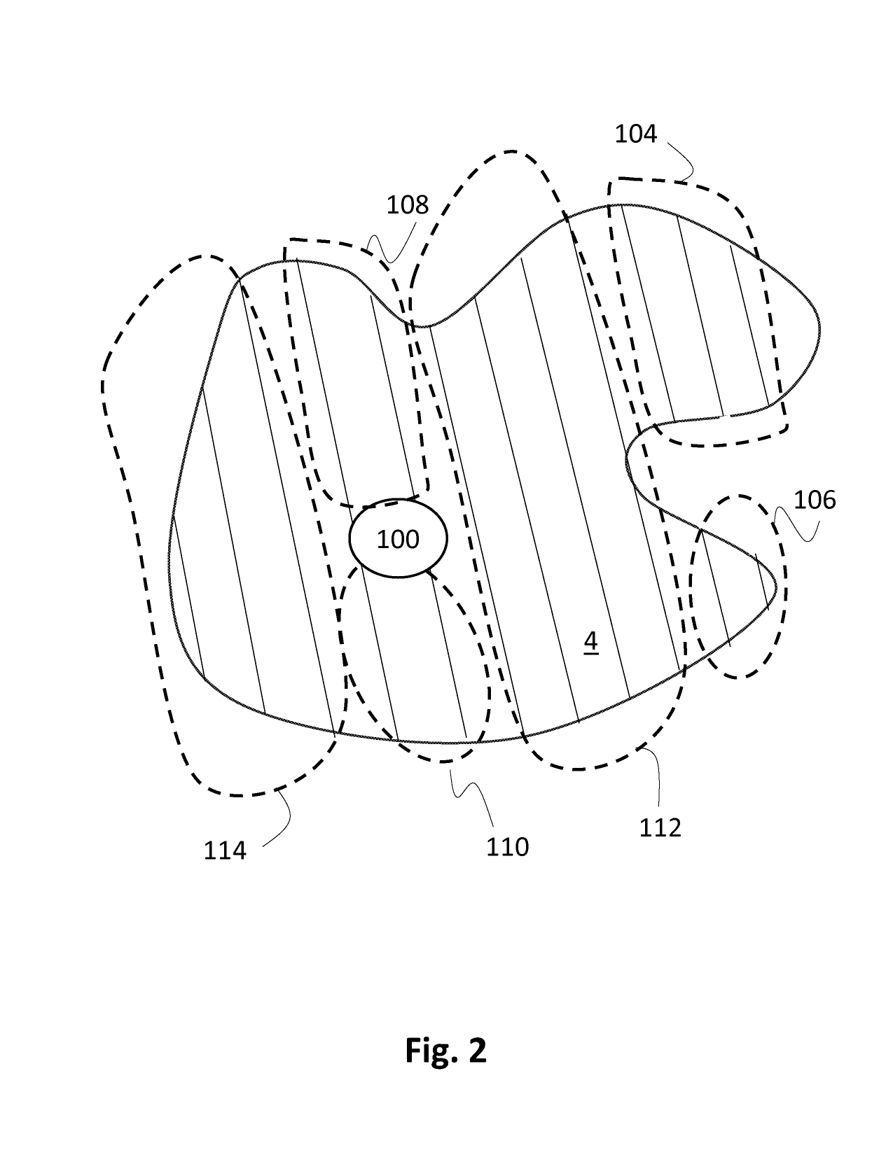

Turning now to FIG. 2 it can be seen that the defined parallel lines 112 have been split into several new lines and that the lines that where inside the non-cutting zones 100 in FIG. 1 have been removed in FIG. 2. Furthermore, according to one embodiment the split lines have been grouped into subsets 104, 106, 108, 110, 112, 114 of lines.

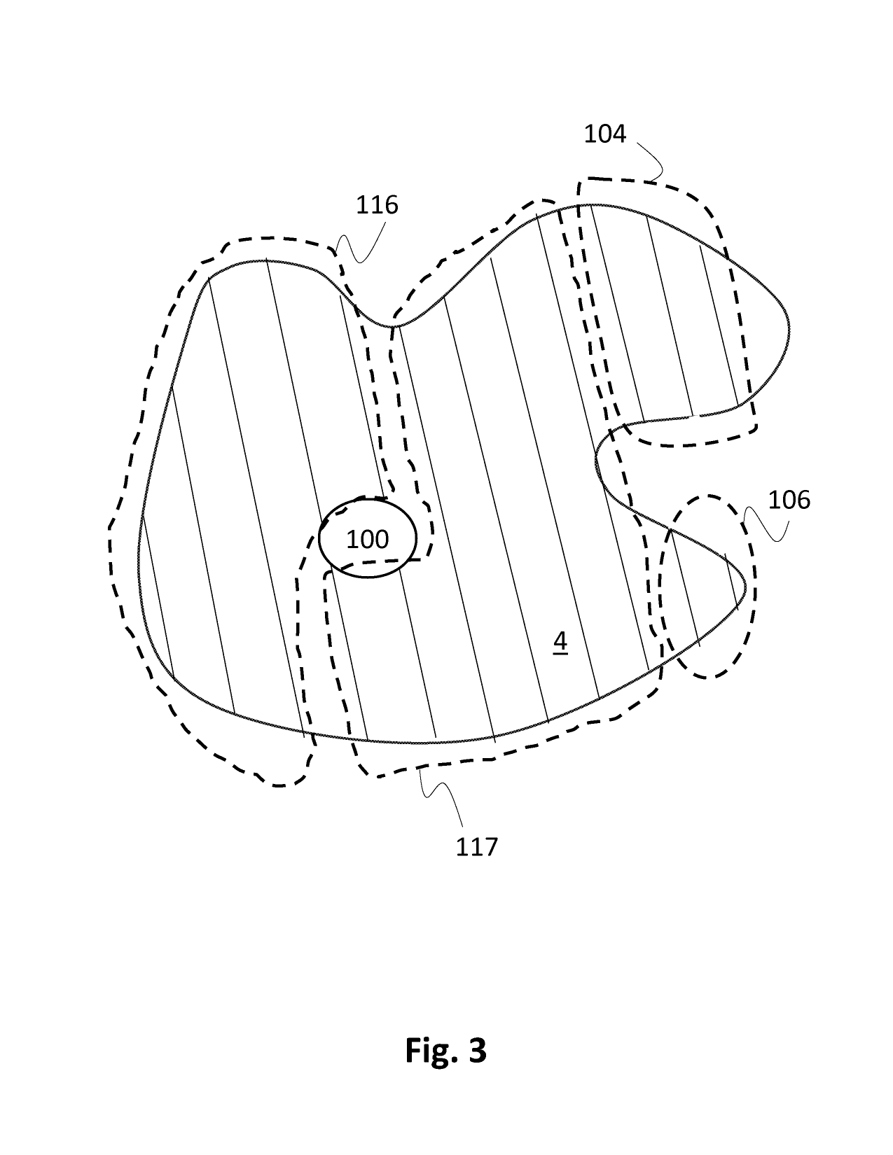

With reference to FIG. 3, some of the subsets 108, 110, 112, 114 have been grouped into composite subsets 116, 117, i.e. subsets 110 and 112 have been grouped into composite subset 117 and subsets 108 and 114 have been grouped into composite subset 116. The remaining subsets 104 and 106 have not been altered.

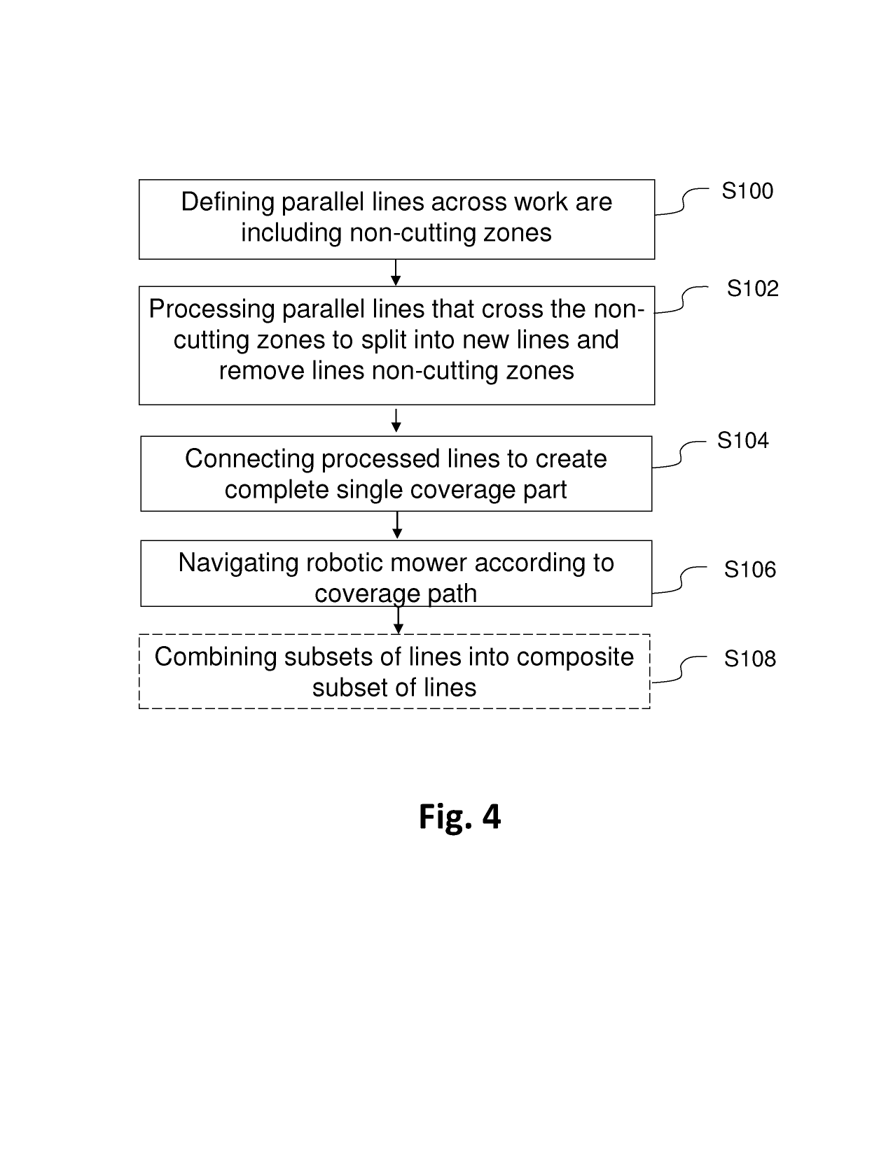

Turning now to FIG. 4, the method according to the present invention will be closer described. In step S100 the parallel lines 102 across the entire work area 4 and the non-cutting zones 100 are defined. In step S102 the parallel lines 102 are processed so that the parallel lines 102 that cross the non-cutting zones 100, are split into several new lines and that the lines that are inside the non-cutting zones 100 are removed. By removing the processed parallel lines that are inside the non-cutting zones 100, the remaining split lines only cover the part of the work are that is to be cut, which means that the robotic mower would not go beyond the predefined cutting area. in step S104 the processed lines are processed to create a complete single coverage path for the robotic mower 2 to follow in order to cut the entire work area 4 excluding the non-cutting zones 100 and in step S106 the robotic mower 2 navigates within the work area 4 based on the created single coverage path. As mentioned above the distance 118, 120 between each parallel line is preferably equal.

According to one embodiment the step S104 of connecting the processed lines into a single coverage path is based on minimizing travelling distance between split co-linear lines.

According to another embodiment the split lines are grouped into subsets 104, 106, 108, 110, 112, 114 of lines, which subsets 104, 106, 108, 110, 112, 114 of lines are connected to minimize the total travelling distance between the subsets 104, 106, 108, 110, 112, 114 of lines.

In yet another embodiment the method further comprises combining, in step S108, at least two subsets 104, 106, 108, 110, 112, 114 of lines into composite subsets 116, 117 of lines and connecting the composite subsets 116, 117 of lines with the remaining subsets 104, 106 of lines to minimize the total travelling distance between composite subsets 116, 117 of lines and the remaining subsets 104, 106 of lines.

With reference to FIG. 5, the robotic mower will be closer described. The robotic mower comprises a controller 12, comprising a processor 14 and a memory 16. Different combinations of general and specific application integrated circuits may be used to realize the controller 12, as is well known in the art.

The present invention also relates to a robotic mower 2 that performs the methods described above, i.e. navigating efficiently along a single coverage path within a work area 4, wherein the work area 4 is limited by a boundary 6 and wherein non-cutting zones are definable both inside and outside of the work area 4. As mentioned above the robotic mower 2 comprises a controller 12 comprising a processor 14 and a memory 16, the memory 16 comprising instructions which when executed by the processer 12 causes the robotic mower to define parallel lines 102 across the entire work area 4 and the non-cutting zones 100, process the parallel lines 102 so that the parallel lines 102 that cross the non-cutting zones 100, are split into several new lines and that the lines that are inside the non-cutting zones 100 are removed, connect the processed lines to create a complete single coverage path for the robotic mower 2 to follow in order to cut the entire work area 4 excluding the non-cutting zones 100, and navigate the robotic mower 2 within the work area 4 based on the created single coverage path. Preferably, the distance 118, 120 between each parallel line is equal.

Furthermore, the robotic mower 2 is also configured to perform all of the different embodiments of the method for navigating the robotic mower 2 as they have been described above.

The present invention also relates to a computer program 18, see FIG. 5, comprising computer program code, and wherein the computer program code being adapted, if executed by the processer 14 of the controller 12, to implement the method and the different embodiments thereof for navigating the robotic mower 2 as have been described above.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean "one and only one" unless explicitly so stated, but rather "one or more." Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method for navigating a robotic mower (2) within a work area (4), wherein the work area (4) is limited by a boundary (6) and wherein non-cutting zones (100) are definable both inside and outside of the work area (4), the method comprising,
defining (S100) parallel lines (102) across the entire work area (4) and the non-cutting zones (100),
processing (S102) the parallel lines (102) so that the parallel lines (102) that cross the non-cutting zones (100), are split into several new lines and that the lines that are inside the non-cutting zones (100) are removed,
connecting (S104) the processed lines to create a complete single coverage path for the robotic mower (2) to follow in order to cut the entire work area (4) excluding the non-cutting zones (100), and
navigating (S106) the robotic mower (2) within the work area (4) based on the created single coverage path.

2. The method according to claim 1, wherein connecting (S104) the processed lines into a single coverage path is based on minimizing travelling distance between split co-linear lines.

3. The method according to claim 1, wherein the split lines are grouped into subsets (104, 106, 108, 110, 112, 114) of lines, which subsets (104, 106, 108, 110, 112, 114) of lines are connected to minimize the total travelling distance between the subsets (104, 106, 108, 110, 112, 114) of lines.

4. The method according to claim 3, further comprising,
combining (S108) at least two subsets (104, 106, 108, 110, 112, 114) of lines into composite subsets (116, 117) of lines and connecting the composite subsets (116, 117) of lines with the remaining subsets (104, 106) of lines to minimize the total travelling distance between composite subset (116, 117) of lines and the remaining subsets (104, 106) of lines.

5. The method according to claim 1, wherein defining (S100) parallel lines (102) comprises defining the distance (118, 120) between each parallel line (102) equal.

6. A robotic mower (2) for performing navigating within a work area (4), wherein the work area (4) is limited by a boundary (6) and wherein non-cutting zones (100) are definable both inside and outside of the work area (4), the robotic mower (2) comprising, a controller (12) comprising a processor (14) and a memory (16), the memory (16) comprising instructions which when executed by the processer (12) causes the mower to:
define parallel lines (102) across the entire work area (4) and the non-cutting zones (100),
process the parallel lines (102) so that the parallel lines (102) that cross the non-cutting zones (100), are split into several new lines and that the lines that are inside the non-cutting zones (100) are removed,
connect the processed lines to create a complete single coverage path for the robotic mower (2) to follow in order to cut the entire work area (4) excluding the non-cutting zones (100), and
navigate the robotic mower (2) within the work area (4) based on the created single coverage path.

7. The robotic mower (2) according to claim 6, wherein the robotic mower (2) is further configured to:
connect the processed lines into a single coverage path based on minimizing travelling distance between split co-linear lines.

8. The robotic mower (2) according to claim 6, wherein the robotic mower (2) is further configured to:
group the split lines into subsets (104, 106, 108, 110, 112, 114) of lines, which subsets (104, 106, 108, 110, 112, 114) of lines are connected to minimize the total travelling distance between the subsets (104, 106, 108, 110, 112, 114) of lines.

9. The robotic mower (2) according to claim 8, wherein the robotic mower (2) is further configured to:
combine at least two subsets (104, 106, 108, 110, 112, 114) of lines into composite subsets (116, 117) of lines and connect the composite subsets (116, 117) of lines with the remaining subset (104, 106) of lines to minimize the total travelling distance between composite subsets (116, 117) of lines and the remaining subsets (104, 106) of lines.

10. The robotic mower (2) according to claim 6, wherein the robotic mower (2) is further configured to define the parallel lines (102) with an equal distance (118, 120) between each parallel line (102).

11. A computer program (18) comprising computer program code, the computer program code being adapted, if executed by the processer (14) of the controller (12), to implement the method according to claim 1.
